(19) United States
(12) Patent Application Publication
(10) Pub. No.: US 2014/0244706 A1
(43) Pub. Date: Aug. 28, 2014

(54) Class of Interlaced Bypass Torus Networks

(71) Applicants: Peng Zhang, Port Jefferson Station, NY (US); Yuefan Deng, Setauket, NY (US)

(72) Inventors: Peng Zhang, Port Jefferson Station, NY (US); Yuefan Deng, Setauket, NY (US)

(21) Appl. No.: 13/773,959

(22) Filed: Feb. 22, 2013

(51) Int. Cl. H04L 29/08

(52) U.S. Cl. CPC H04L 67/10
USPC 709/201

(57) ABSTRACT

The present invention provides a class of networks by systematically interlacing bypass links to torus or mesh networks, resulting in networks called interlaced bypass torus (iBT) networks. The iBT network is a d-dimensional mesh-like network (d≧2) at which only two more bypass links are added to each of these processing elements (or node) in the original torus or mesh network. It can be conveniently adopted to the interconnection networks of parallel computers and the interconnection networks of storage systems. The parallel computer system integrates a plurality of processing elements in which each element performs data processing and message switching with other elements. The storage system integrates a plurality of storage elements in which each element facilities data access: write and read. These aforesaid parallel systems with elements interconnected as the novel iBT networks are wholly defined as an iBT-based parallel processing system and the storage systems are defined as iBT-based parallel storage system.

### FIELD OF THE INVENTION

The present invention relates generally to the field of advanced networking architectures in parallel processing systems, large scale switching systems, and parallel storage network systems. More specifically, the present invention relates to an interlaced bypass torus (iBT) network that is built by systematically interlacing bypass links to torus or mesh networks.

### BACKGROUND OF THE INVENTION

Advanced networking architectures have helped enable parallel computers to constantly break the performance barriers and such progress has stimulated the parallel computing community's ambitions to invent more scalable interconnection networks to accommodate the ever-increasing demands of performance and functionalities by incorporating millions of powerful processor cores. A scalable interconnection network, of a fixed node degree, must satisfy most of the performance requirements including small diameter, large bisection width, topological simplicity, high-degree symmetry, design modularity, and engineering feasibility, as well as expandability. For example, a 3D torus network such as those in the IBM's Blue Gene and Cray's T3E with up to 20 thousand nodes and several small-scale hypercube networks satisfy several of the requirements. However, the network diameters grow too fast for a torus, a hypercube and many of their derivatives. This defect of rapidly growing diameters greatly limits the expandability of these networks. Mesh networks of fixed dimension provide an alternative with relatively low node-degree and low engineering complexity but with large network diameter and small overall bandwidth. Other efforts to increase bandwidth without increasing network diameters include that of the hybrid fat-tree, a low-cost, low-degree network with irregular node degree; however, it is susceptible to faulty links and to message contention towards roots. Other proposals have also been introduced, such as the incomplete torus and its derivatives that reduce node degree at the expense of losing symmetry and topological simplicity. Honeycomb mesh and torus networks received considerable early attention that faded quickly due to implementation obstacles, among other difficulties. Hexagonal networks introduced also boast a small diameter but carry a burden of a high node degree. Modifications of the traditional torus including the Packed Exponential Connections, Shifted Recursive Torus, TESH, and Recursive Diagonal Torus networks all build upon the simplicity of mesh and torus networks, achieving improved network properties with unfavorable expandability and network cost. However, these variants demonstrated that interlacing rings of various lengths to a torus network is a profitable practice for improving network performance without adding significant engineering complexity.

Motivated by this and several other needs for massive storage systems, we invent a class of iBT networks. The iBT network is constructed by interlacing bypass links evenly in a torus or mesh network. We preserve the simplicity of grid-like layout and improve the performance of the network with minimal number of bypass links. Our model allows generalization of the bypass construction of the base torus to arbitrary dimensions for much larger and scalable networks than 2D. This new network achieves a low network diameter, high bisection width, short node-to-node distances, quick collective operations including broadcast, and low engineering complexity in terms of network cost. Furthermore, the iBT network has much lower node degree and lower network cost than a hypercube of the similar network size does. To ensure network symmetry and modularity, we interlace rings into the torus network consistently.

### SUMMARY OF THE INVENTION

The objective of the present invention is to provide a class of d-dimensional interlaced bypass torus (iBT) networks for the interconnection network of parallel processing systems and the interconnection network of massive parallel storage network systems where d≧2. The d-dimensional iBT network is generated from a general d-dimensional torus or mesh network by adding a pair of bypass links to each processing element (PE). The distinguished features of the iBT networks include: the iBT network can be extended to a general d-dimensional case (d≧2); only one pair of bypass links are added to each PE along a single dimension; the selection of bypass links lengths does not change as the system size increases.

The other objective is to provide a parallel processing system that used the iBT network as its interconnection network. The parallel processing system can be a parallel computer consisting of a plurality of processing elements or a parallel storage system consisting of a plurality of storage elements. In the interconnection network of parallel computers, each processing element is a processor, a processor core or an integrated compute node of the parallel processing system. Such element is to perform data processing and message switching with other elements. In the interconnection network of storage systems, each storage element is one or several disks of various types or any data storage device, and its network controller. Such element is to provide storage resources to the network for primary data store, mirror data store, backup data store and data access: read and write.

### BRIEF DESCRIPTION OF THE DRAWINGS

FIG. 1 illustrates all of the torus and bypass links in a 2D iBT(8×8; L=2; b= [symbol] 4 [symbol] ) in which each PE interconnects 4 torus neighbors by torus links and 2 bypass neighbors by x-dimensional or y-dimensional 4-hop bypass links. Each PE has two of either x-dimensional or y-dimensional bypass links and it has different bypass dimensions from its torus neighbors. All of the bypass links are of length 4 hops.

FIG. 2 illustrates all of the torus and bypass links in a 2D iBT(8×8; L=2; b₁= [symbol] 2 [symbol] , b₂= [symbol] 4 [symbol] ) in which each PE interconnects 4 torus neighbors by torus links and 2 bypass neighbors by x-dimensional 2-hop or y-dimensional 4-hop bypass links. Each PE has two of either x-dimensional or y-dimensional bypass links and it has different bypass dimensions and bypass link lengths from its torus neighbors.

FIG. 3 illustrates the bypass arrangement for 3D iBT(30×30×36; L=3; b= [symbol] 6,12 [symbol] ). We only draw the bypass links along the three easily visible edges to identify the nodes that are connected by the appropriate bypass links. Other links are omitted for the purpose of clarity.

FIG. 4 illustrates the bypass links for 3D iBT(9×9×9; L=3; b= [symbol] 3 [symbol] ). We only draw all of the 3-hop bypass links and omit the torus links for the purpose of clarity. Each bead represents a PE. In the network, each PE is interconnected to four torus PE's by torus links and two 3-hop bypass neighbors by bypass links.

### DETAILED DESCRIPTION OF THE PREFERRED EMBODIMENT

The present invention is to provide a class of interlaced bypass torus (iBT) networks and a parallel processing system by the novel iBT network, in order to improve the interconnection network design of parallel processing systems.

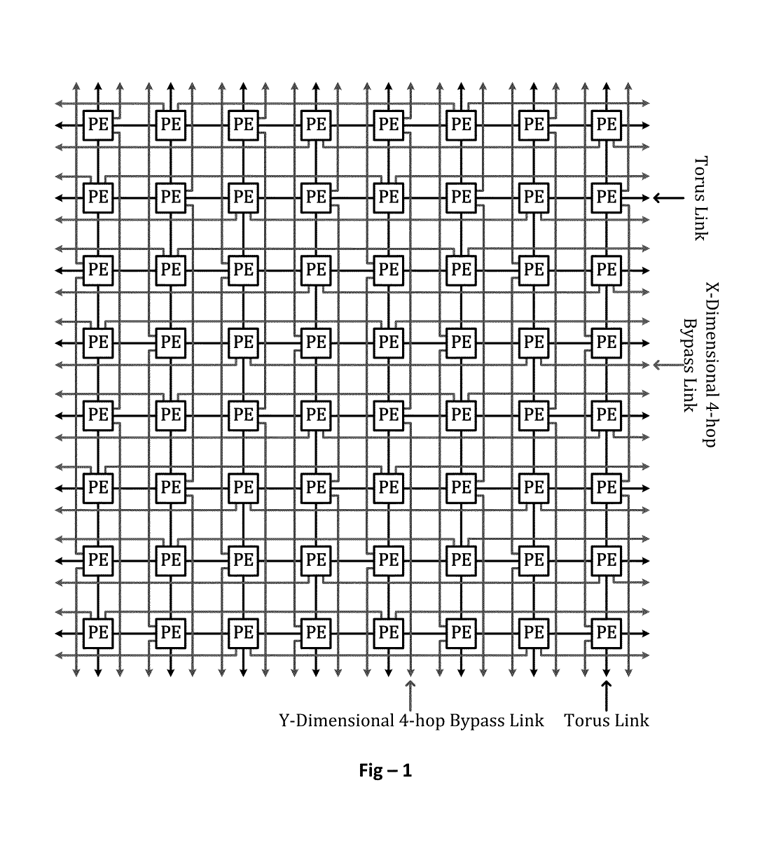

With the illustrative clarity of the FIG. 1 to FIG. 4, the detailed technology embodiments of the present invention are:

Definition of the iBT network: A general d-dimensional iBT network (d≧2) starts from a torus network of dimensions N₁×N₂× . . . ×N_{d} is denoted as iBT (N₁×N₂× . . . ×N_{d}; L=m; b= [symbol] b₁, b₂, . . . , bₖ [symbol] ).

In this notation, b= [symbol] b₁, b₂ . . . , bₖ [symbol] is referred to as the bypass scheme and it is a strictly increasing vector, i.e., b₁<b₂< . . . <bₖ. L=m; b= [symbol] b₁, b₂ . . . , bₖ [symbol] means that we interlace bᵢ-hop bypass rings (i=1, . . . , k) recursively into the first m dimensions (m<d). When k=1, b=(b₁) is referred to as a uniform bypass scheme; otherwise, b= [symbol] b₁, b₂ . . . , bₖ [symbol] (k≧2) is referred to as a mixed bypass scheme.

In an iBT network, each coordinate x=(x₁, x₂, . . . , x_{d}) represents a processing element (PE), where xⱼε[0, Nⱼ−1] is an integer and jε[1, d]. APE is a unit that is able to perform data processing and message switching with other processing elements.

In this d-dimensional iBT network as defined in [0012], each PE interconnects 2d+2 other PE's so the node degree, defined as the number of links from a PE to its neighbors, is 2d+2 where 2d and 2 are from the torus and bypass links, respectively.

Definition of a torus neighbor of a PE x=(x₁, x₂, . . . , x_{d}): Assume x=(x₁, x₂, . . . , x_{d}) and y=(y₁, y₂, . . . , y_{d}) be two PE's in the iBT network, a torus distance Dₜ(x, y) between these two PE's is defined as Dₜ(x,y)=Σⱼ₌₁^{d} min{|xⱼ−yⱼ|,Nⱼ−|xⱼ−yⱼ|}.

There is a torus link that interconnects x and y if and only if Dₜ(x,y)=1; otherwise, there is no torus link that interconnects these two PE's. y is a torus neighbor of x if and only if there is a torus link that interconnects x and y. Therefore, the same as in a torus network, each PE in the iBT network has 2d torus neighbors by torus links.

Definition of a bypass neighbor of a PE x=(x₁, x₂, . . . , x_{d}): To determine the one pair of bypass links for x=(x₁, x₂, . . . , x_{d}), we introduce two terms: a node bypass dimension bd(x)ε[1, . . . , m] and a node bypass length bl(x)ε{b₁, . . . , bₖ} which can be expressed as bd(x)=[s (mod m)]+1 and bl(x)=bₕ where

$$h = ⌊ \frac{[ s ( mod mk ) ]}{m} ⌋ + 1$$

$$and$$

$$s = {\sum }_{l = 1}^{m} {x}_{l} .$$

Thus, it indicates: two bl(x)-hop bypass links are added to x in each direction along the dimension bd(x). Here, [α (mod β)] means a modulus, on division of α by β, and └α┘ means the largest previous integer not greater than α.

A PE y is a bypass neighbor of x if and only if there is a bypass link that interconnects x and y.

Qualification conditions for a bypass scheme b= [symbol] b₁, b₂ . . . , bₖ [symbol] : iBT(N₁×N₂× . . . ×N_{d}; L=m; b= [symbol] b₁, b₂ . . . , bₖ [symbol] ) is a qualified iBT network if and only if its configurations satisfy the following four conditions as in [0021] to [0024]:

Condition I: Nₗ≡0 (mod m) where lε[1, m];

Condition II: bᵢ≡0 (mod mk) where iε[1, k];

Condition III: bₕ ≡0 (mod bᵢ) where 1≦i≦h≦k;

Condition IV: [Nₗ (mod b₁)]≡0 (mod mk) where lε[1, m].

Here Condition I ensures that bypass rings are interlaced in the first m directions. Conditions II and III ensure that a bypass link always interconnects a pair of PE's of both the same bypass dimension and the same bypass length. Condition IV ensures that all of the bypass links form rings in a mixed bypass scheme. Here α≡γ(mod β) means [α (mod β)]≡[γ (mod β3)].

The other definition of the iBT network is: A general d-dimensional iBT network (d≧2) starts from a mesh network of dimensions N₁×N₂× . . . ×N_{d} is denoted as iBT(N₁×N₂× . . . ×N_{d}; L=m; b= [symbol] b₁, b₂ . . . , bₖ [symbol] ).

The notations L=m; b= [symbol] b₁, b₂ . . . , bₖ [symbol] as used in the definition of [0026] have the same meanings as defined in [0013].

Definition of a mesh neighbor of a PE x=(x₁, x₂, . . . , x_{d}): Assume x=(x₁, x₂, . . . , x_{d}) and y=(y₁, y₂, . . . , y_{d}) be two PE's in this iBT network, a mesh distance Dₘ(x, y) between these two PE's is defined as Dₘ(x,y)=Σⱼ₌₁^{d}|xⱼ−yⱼ|.

There is a mesh link that interconnects x and y if and only if Dₘ(x,y)=1; otherwise, there is no mesh link that interconnects these two PE's. y is a mesh neighbor of x if and only if there is a mesh link that interconnects x and y. Therefore, the same as in a mesh network, each PE in the iBT network has, at most, 2d mesh neighbors by mesh links.

The definition of a bypass neighbor as in for the iBT network defined in [0026] is the same as in [0018] to [0019]. Qualification conditions for a bypass scheme defined in [0021] through [0024] still apply for the iBT network defined in [0026].

The only difference between the definition in [0012] and the definition in [0026] is different selections of base networks, specifically, the former iBT network in [0012] uses a torus as a base network and the latter one in [0026] uses a mesh as a base network.

Definition of a more general iBT network: a more general d-dimensional iBT network is denoted as: iBT(N₁× . . . ×N_{d}; L=ₘ; b₁= [symbol] b₁₁, . . . , b₁ₖ_{₁} [symbol] , b₂= [symbol] b₂₁, . . . , b₂ₖ_{₂} [symbol] , . . . bₘ= [symbol] bₘ₁, . . . , b₁ₖ_{ₘ} [symbol] ).

In this notation, bₗ= [symbol] bₗ₁, . . . , bₗₖ_{ₗ} [symbol] is referred to as the bypass scheme for dimension l where lε[1, m] and it means that we interlace bₗᵣ-hop bypass rings (rε[1, kₗ]) recursively into the dimension l. When

$${b}_{1} ≡ … ≡ {b}_{m} {=}^{Δ} b ,$$

the more general case becomes the case defined in [0012].

In this more general case, the base network of N₁× . . . ×N_{d} can be either a torus or a mesh network.

In this more general case, if the base network is a torus network, each PE has 2d+2 neighbors where 2d torus and 2 bypass neighbors by torus and bypass links, respectively; if the base network is a mesh network, each PE has 2 bypass neighbors and, at most, 2d mesh neighbors.

In this more general case, the node bypass dimension is expressed as: bd(x)=[s(mod m)]+1 where s=Σₗ₌₁^{m}xₗ and the node bypass length is expressed as: bl(x)=bₕ where

$$h = ⌊ \frac{[ s ( mod {mk}_{bd ( x )} ) ]}{m} ⌋ + 1.$$

Thus, it indicates: two bl(x)-hop bypass links are added to x in each direction along the dimension bd(x).

Qualification conditions for the bypass scheme defined in [0032]:

iBT(N₁× . . . ×N_{d}; L=m; b₁= [symbol] b₁₁, . . . , b₁ₖ_{₁} [symbol] , b₂= [symbol] b₂₁, . . . , b₂ₖ_{₂} [symbol] , . . . bₘ=(bₘ₁, . . . , b₁ₖ_{ₘ} [symbol] ) is a qualified iBT network if and only if its configurations satisfy the following four conditions as in [0039] through [0042]:

Condition I: Nₗ≡0 (mod m) where lε[1, m];

Condition II: bₗᵢ≡0 (mod mkₗ) where iε[1, kₗ];

Condition III: bₗₕ≡0 (mod bₗᵢ) where 1≦i≦h≦kₗ;

Condition IV: [Nₗ(mod bₗ₁)]≡0 (mod mkₗ) where lε[1, m].

An exemplary embodiment of 2D iBT(8×8; L=2; b= [symbol] 4 [symbol] ), or equally iBT(8×8; L=2; b₁= [symbol] 4 [symbol] , b₂= [symbol] 4 [symbol] ), is shown in FIG. 1. Each PE has four torus neighbors and two 4-hop bypass neighbors by either x-dimensional or y-dimensional bypass links.

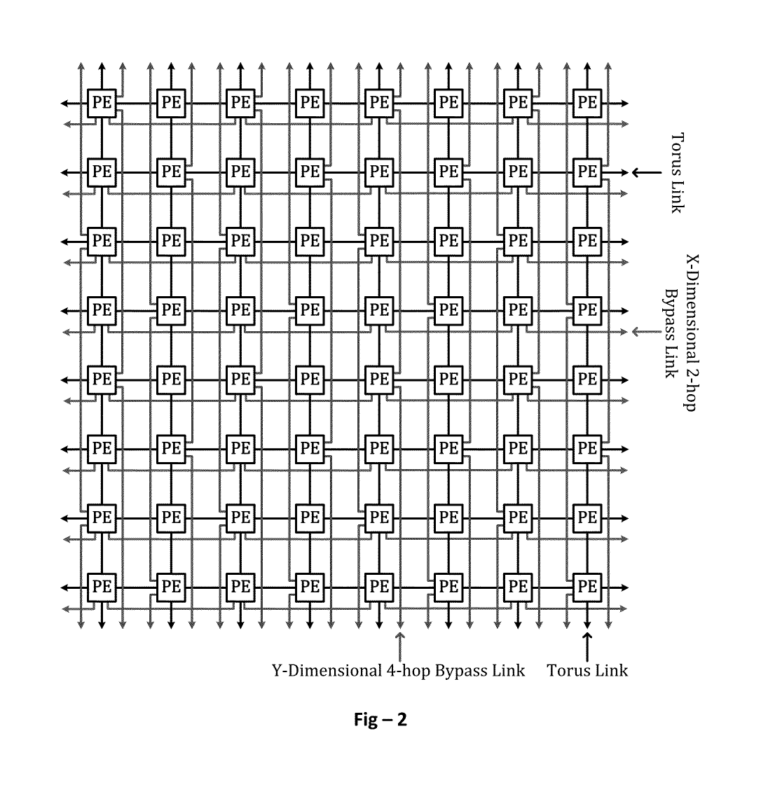

An exemplary embodiment of 2D iBT(8×8; L=2; b₁= [symbol] 2 [symbol] , b₂= [symbol] 4 [symbol] ) is shown in FIG. 2. Each PE has four torus neighbors and two bypass neighbors by either x-dimensional 2-hop or y-dimensional 4-hop bypass links. If a PE has x-dimensional 2-hop (or y-dimensional 4-hop) bypass links, its four torus neighbors have y-dimensional 4-hop (or x-dimensional 2-hop) bypass links.

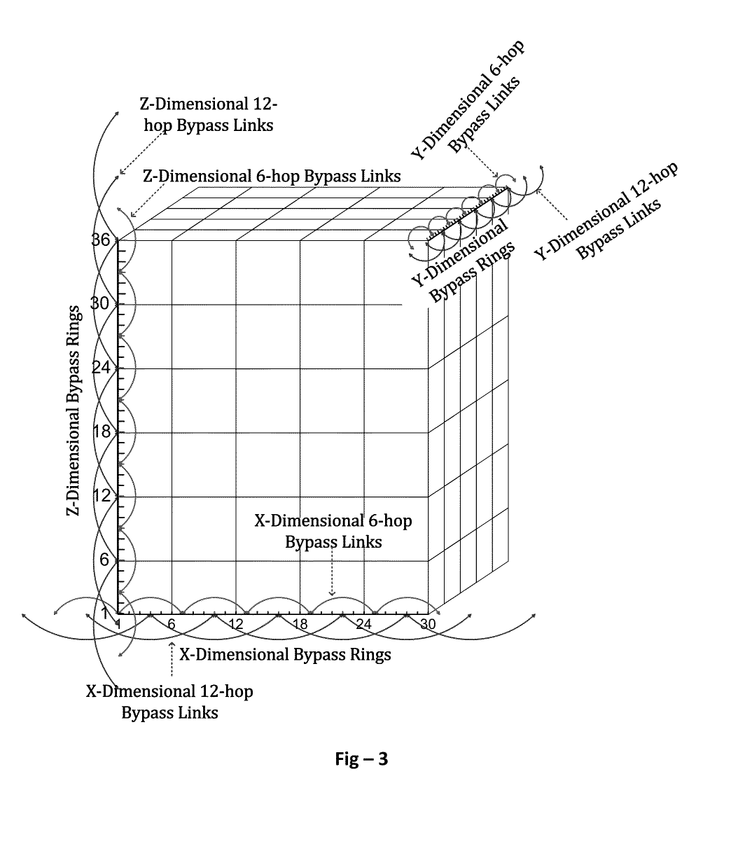

An exemplary embodiment of 3D iBT(30×30×36; L=3; b= [symbol] 6,12 [symbol] ), or equally iBT(30×30×36; L=3; b₁= [symbol] 6,12 [symbol] , b₂= [symbol] 6,12 [symbol] , b₃= [symbol] 6,12 [symbol] ), is shown in FIG. 3.

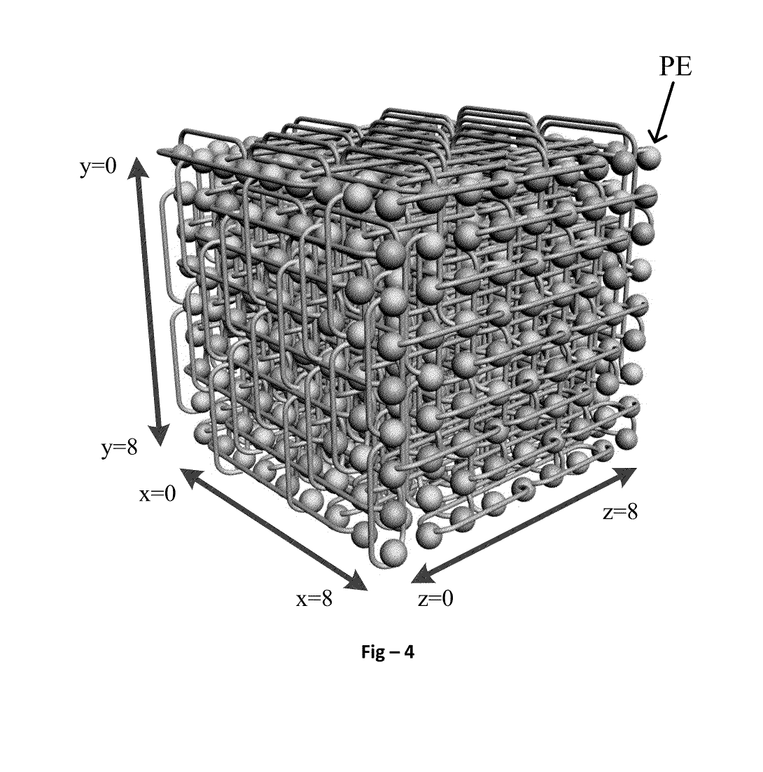

An exemplary embodiment of 3D iBT(9×9×9; L=3; b= [symbol] 3 [symbol] ), or equally iBT(9×9×9; L=3; b₁= [symbol] 3 [symbol] , b₂= [symbol] 3 [symbol] , b₃= [symbol] 3 [symbol] ), is shown in FIG. 4. All of the 3-hop bypass links form rings and torus links are omitted for the purpose of clarity.

According to the present iBT networks as defined in [0012], [0026] and [0032], N processing elements are able to be integrated as a whole parallel processing system where N=Πⱼ₌₁^{d}Nⱼ. These processing elements are interconnected as in the iBT network. In other words, the interconnection network of the parallel processing system is built using the iBT network. Each processing element performs data processing and message switching with its torus (or mesh) and bypass neighbors. A processing element can be a processor core, a processor or an integrated compute node with a router or switch for message switching.

According to the present iBT network as defined in [0012], [0026] and [0032], N data storage elements are able to be integrated as a whole massive storage network system where N=Πⱼ₌₁^{d}Nⱼ. These storage elements are interconnected as in the iBT network. In other words, the interconnection network of massive storage network systems is built using the iBT network. Each storage element provides storage resources to the network for primary data store, mirror data store, backup data store and data access. A storage element can be one or several disks of various types, or any data storage device, and a network controller for providing data access: read and write.

1. A d-dimensional interlaced bypass torus (iBT) network (d≧2) comprises:
a d-dimensional torus network of dimensions N₁×N₂× . . . ×N_{d} in which each coordinate x=(x₁, x₂, . . . , x_{d}) represents a processing element, in which xⱼε[0, Nⱼ−1] is an integer and jε[1, d], and each processing element has 2d torus links in d dimensions to interconnect 2d torus neighbors;
an interlaced bypass network of bypass scheme L=m; b= [symbol] b₁, b₂ . . . , bₖ [symbol] in which each processing element x has two bl(x)-hop bypass links in each direction along the dimension bd(x) to interconnect two bypass neighbors, in which bd(x)=[s(mod m)]+1, bl(x)=bₕ,
$$h = ⌊ \frac{[ s ( mod mk ) ]}{m} ⌋ + 1$$
$$and$$
$$s = {\sum }_{l = 1}^{m} {x}_{l} .$$

2. The interlaced bypass torus (iBT) network as claimed in claim 1, wherein said processing element performs computation, data processing and message switching with its torus and bypass neighbors.

3. The interlaced bypass torus (iBT) network as claimed in claim 1, wherein each said processing elements has 2d torus neighbors and 2 bypass neighbors.

4. A d-dimensional interlaced bypass torus (iBT) network (d≧2) comprises:
a d-dimensional mesh network of dimensions N₁×N₂× . . . ×N_{d} in which each coordinate x=(x₁, x₂, . . . , x_{d}) represents a processing element, in which xⱼε[0, Nⱼ−1] is an integer and jε[1, d], and each processing element interconnects its mesh neighbors;
an interlaced bypass network of bypass scheme L=m; b= [symbol] b₁, b₂ . . . , bₖ [symbol] in which each processing element x has two bl(x)-hop bypass links in each direction along the dimension bd(x) to interconnect two bypass neighbors, in which bd(x)=[s(mod m)]+1, bl(x)=bₕ,
$$h = ⌊ \frac{[ s ( mod mk ) ]}{m} ⌋ + 1$$
$$and$$
$$s = {\sum }_{l = 1}^{m} {x}_{l} .$$

5. The interlaced bypass torus (iBT) network as claimed in claim 4, wherein said processing element performs computation, data processing and message switching with its mesh and bypass neighbors.

6. A d-dimensional interlaced bypass torus (iBT) network (d≧2) comprises:
a d-dimensional torus network of dimensions N₁×N₂× . . . ×N_{d} in which each coordinate x=(x₁, x₂, . . . , x_{d}) represents a processing element, in which xⱼε[0, Nⱼ−1] is an integer and jε[1, d], and each processing element has 2d torus links in d dimensions to interconnect 2d torus neighbors;
an interlaced bypass network of bypass scheme L=m; b₁= [symbol] b₁₁, . . . , b₁ₖ_{₁} [symbol] , b₂= [symbol] b₂₁, . . . , b₂ₖ_{₂} [symbol] , bₘ= [symbol] bₘ₁, . . . , b₁ₖ_{ₘ}) in which each processing element x has two bl(x)-hop bypass links in each direction along the dimension bd(x) to interconnect two bypass neighbors, in which bd(x)=[s(mod m)]+1, bl(x)=bₕ,
$$h = ⌊ \frac{[ s ( mod {mk}_{bd ( x )} ) ]}{m} ⌋ + 1$$
$$and$$
$$s = {\sum }_{l = 1}^{m} {x}_{l} .$$

7. The interlaced bypass torus (iBT) network as claimed in claim 6, wherein said processing element performs computation, data processing and message switching with its neighbors.

8. A d-dimensional interlaced bypass torus (iBT) network (d≧2) comprises:
a d-dimensional mesh network of dimensions N₁×N₂× . . . ×N_{d} in which each coordinate x=(x₁, x₂, . . . , x_{d}) represents a processing element, in which xⱼε[0, Nⱼ−1] is an integer and jε[1, d], and each processing element interconnects its mesh neighbors;
an interlaced bypass network of bypass scheme L=m; b₁= [symbol] b₁₁, . . . , b₁ₖ_{₁} [symbol] , b₂= [symbol] b₂₁, . . . , b₂ₖ_{₂} [symbol] , bₘ= [symbol] bₘ₁, . . . , b₁ₖ_{ₘ} [symbol] in which each processing element x has two bl(x)-hop bypass links in each direction along the dimension bd(x) to interconnect two bypass neighbors, in which bd(x)=[s(mod m)]+1, bl(x)=bₕ,
$$h = ⌊ \frac{[ s ( mod {mk}_{bd ( x )} ) ]}{m} ⌋ + 1$$
$$and$$
$$s = {\sum }_{l = 1}^{m} {x}_{l} .$$

9. The interlaced bypass torus (iBT) network as claimed in claim 8, wherein said processing element performs computation, data processing and message switching with its neighbors.

10. A parallel processing system comprising N processing elements and an interconnection network for interconnecting processing elements, wherein said interconnection network is the interlaced bypass torus (iBT) network as claimed in claim 1 and N=Πⱼ₌₁^{d}Nⱼ.

11. A parallel processing system comprising N processing elements and an interconnection network for interconnecting these processing elements, wherein said interconnection network is the interlaced bypass torus (iBT) network as claimed in claim 4 and N=Πₙ₌₁^{d}Nₙ.

12. A parallel processing system comprising N processing elements and an interconnection network for interconnecting these processing elements, wherein said interconnection network is the interlaced bypass torus (iBT) network as claimed in claim 6 and N=Πₙ₌₁^{d}Nₙ.

13. A parallel processing system comprising N processing elements and an interconnection network for interconnecting these processing elements, wherein said interconnection network is the interlaced bypass torus (iBT) network as claimed in claim 8 and N=Πₙ₌₁^{d}Nₙ.

14. A storage system comprising N storage elements wherein an interconnection network for interconnecting these storage elements is the interlaced bypass torus (iBT) network as claimed in claim 1, said storage element is to provide to the network for data storage and data access and N=Πₙ₌₁^{d}Nₙ.

15. A storage system comprising N storage elements wherein an interconnection network for interconnecting these storage elements is the interlaced bypass torus (iBT) network as claimed in claim 4, said storage element is to provide to the network for data storage and data access and N=Πₙ₌₁^{d}Nₙ.

16. A storage system comprising N storage elements wherein an interconnection network for interconnecting these storage elements is the interlaced bypass torus (iBT) network as claimed in claim 6, said storage element is to provide to the network for data storage and data access and N=Πₙ₌₁^{d}Nₙ.

17. A storage system comprising N storage elements wherein an interconnection network for interconnecting these storage elements is the interlaced bypass torus (iBT) network as claimed in claim 8, said storage element is to provide to the network for data storage and data access and N=Πₙ₌₁^{d}Nₙ.
